(19) United States
(12) Patent Application Publication
(10) Pub. No.: US 2007/0159154 A1
(43) Pub. Date: Jul. 12, 2007

(54) Voltage regulator circuit arrangement

(75) Inventors: Aloysius Johannes Maria Boomkamp, Nijmegen (NL); Harm Gerwin Joan Voss, Nijmegen (NL); Stefan Gerhard Erich Butselaar, Nijmegen (NL); Clemens Gerhardus Johannes Haas, Nijmegen (NL); Gerrit Jan Bollen, Nijmegen (NL); Ruurd Anne Visser, Nijmegen (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., Eindhoven (NL)

(21) Appl. No.: 10/586,832

(22) PCT Filed: Jan. 10, 2005
(86) PCT No.: PCT/IB05/50102

§ 371 Date: Jul. 19, 2006

(30) Foreign Application Priority Data
Jan. 21, 2004 (EP) 04100188.4

(51) Int. Cl. G05F 3/16

(52) U.S. Cl. 323/313

(57) ABSTRACT

The invention relates to a voltage regulator circuit arrangement comprising a voltage regulator for generating an out-put voltage in dependence of a reference signal, characterized in that a reference signal generation circuit is provided for generating said reference signal comprising a plurality of inputs connected to internal terminals, whereby a sub-set of said plurality internal terminals is connected to an external terminal.

The invention relates to a voltage regulator circuit arrangement as defined in the preamble of claim 1.

The invention also relates to an integrated circuit comprising a voltage regulator circuit.

Such voltage regulator circuit arrangements are commonly used, for example for generating supply voltages for micro-controllers and micro-processors. Different types and applications may require different supply voltage levels. In practice a wide variety of supply voltage levels exists.

In practice a design of a voltage regulator circuit arrangement is used to obtain several output voltages. The output voltage generated by the voltage regulator circuit arrangement is adapted by changing component values of one or more components in the arrangement. In case the voltage regulator circuit arrangement is realized as an integrated circuit this implies that for a different output voltage a number of masks has to be modified. It may even be the case that a complete mask set has to be modified. Thus each output voltage requires a separate mask set, although the basic design of the voltage regulator circuit does not change. Furthermore due to the throughput time of IC processing this approach is rather inflexible.

A known solution to overcome this disadvantage is a voltage regulator circuit arrangement having a number of programming inputs, each of which is either connected to a first reference voltage or to a second reference voltage, different from the first. Especially if the voltage regulator arrangement is designed as an integrated circuit this a disadvantage, since each programming input is an additional external input that requires an external pin and in general one would like to reduce the number of external pins as much as possible.

Amongst others it is an object of the invention to provide a voltage regulator circuit arrangement with a reduced number of external terminals.

To this end the invention provides a voltage regulator circuit arrangement as defined in the opening paragraph which is characterized by the characterizing part of claim 1.

In this way the number of external terminals of the voltage regulator circuit arrangement is reduced. An advantage of the voltage regulator circuit arrangement according to the invention is that it is possible to change its output voltage by connecting a different sub-set of the plurality of internal terminals to the external terminal.

### The above and other objects, features, and embodiments of the present invention will become more apparent from the following detailed description considered in connection with the accompanying drawings in which:

FIG. 1 shows a schematic diagram of a voltage regulator circuit arrangement according to the invention;

FIG. 2 shows a schematic diagram of an embodiment of the voltage regulator circuit arrangement according to the invention;

FIG. 3 shows a schematic diagram of another further embodiment of the voltage regulator circuit arrangement according to the invention;

FIG. 4 shows a schematic diagram of another further embodiment of the voltage regulator circuit arrangement according to the invention; and

FIG. 5 shows a schematic diagram of another further embodiment of the voltage regulator circuit according to the invention.

### In these figures identical parts are in general identified with identical references.

FIG. 1 shows a schematic diagram of a voltage regulator circuit arrangement according to the invention. The arrangement 100 comprises a voltage regulator 102 that in operation supplies an output voltage Vout at its output 104. The output voltage Vout is generated in dependence of a reference voltage Vref supplied at its input. The reference voltage Vref is generated by a reference voltage generation circuit 101. The reference voltage generation circuit has a plurality of inputs 11, 12, . . . , Im which are connected to corresponding internal terminals T1, T2, . . . , Tm. A sub-set of the internal terminals T1, T2, . . . , Tm is connected to an external terminal 103.

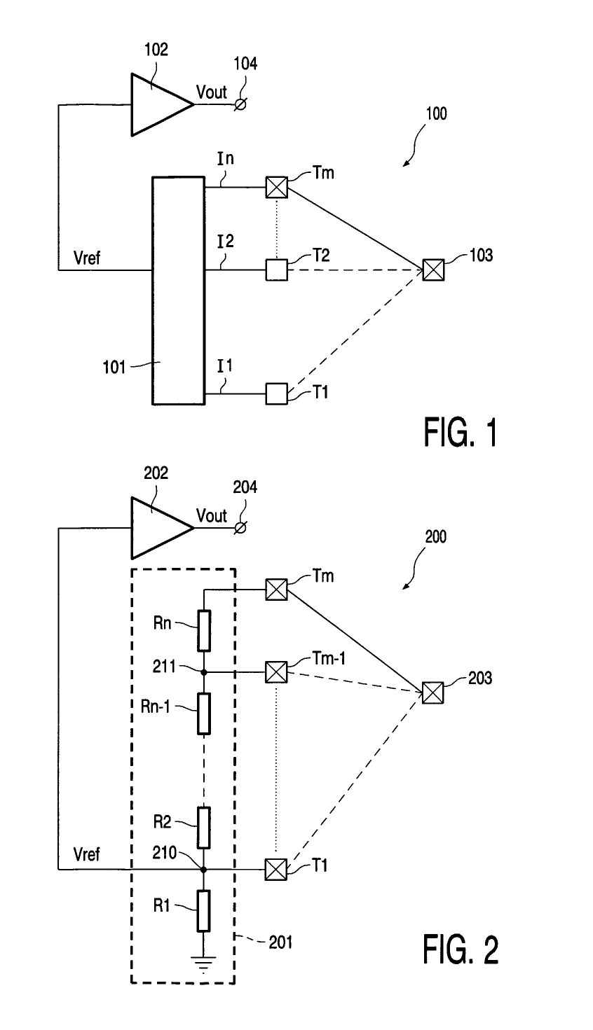

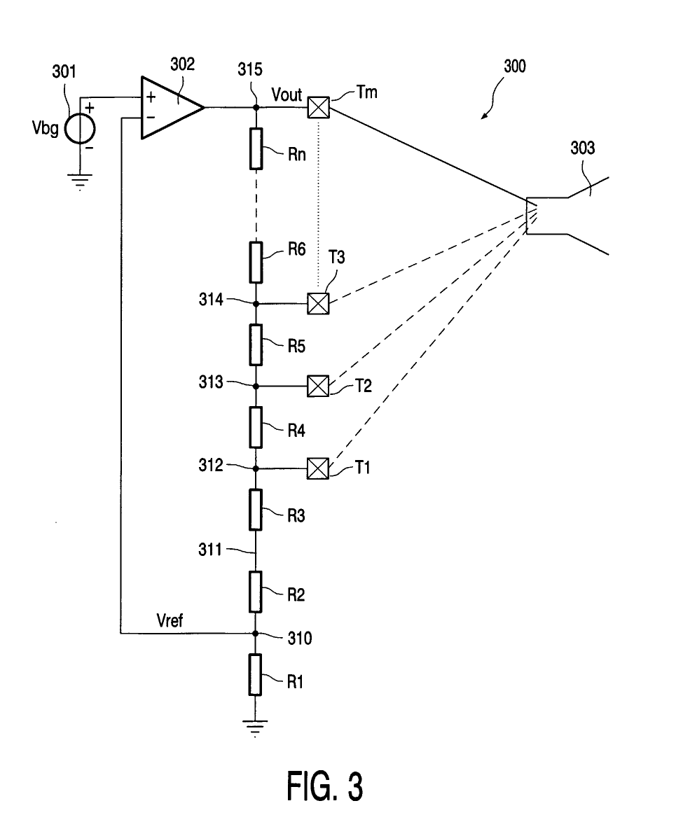

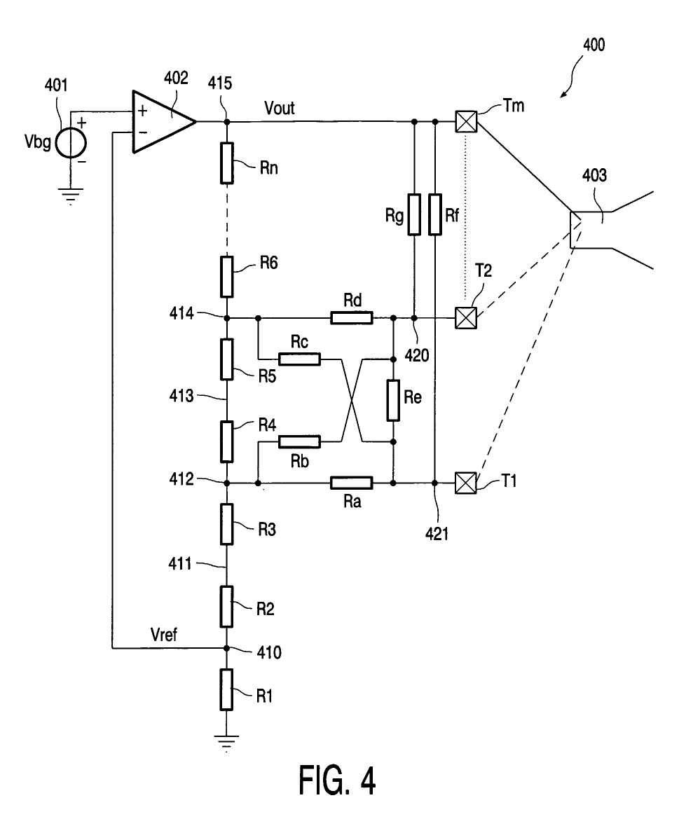

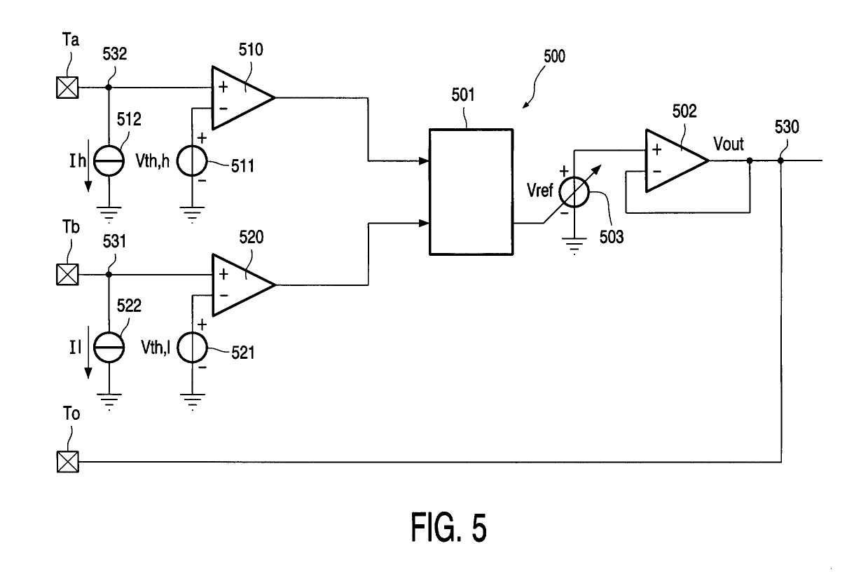

In practice the voltage regulator 102, the reference signal generation circuit, and the internal terminals T1, T2, . . . , Tm could be part of an integrated circuit whereby T1, T2, . . . , Tm are bondpads of the integrated circuit. External terminal 103 could be a lead finger with in an integrated circuit package which is connected to an out side pin or contact area of the integrated circuit package. Only a sub-set of the internal terminals T1, T2, . . . , Tm is connected to external terminal 103, thereby reducing the required number of external terminals and thus in practice reducing the required number of pins of an integrated circuit package. In the voltage regulator arrangement shown in FIG. 1 only internal terminal Tm is connected to external terminal 103, as is indicated by the continuous line between internal terminal Tm and external terminal 103. Possible connections between other internal terminals and external terminal 103 are indicated by broken lines. It will be clear that more than a number of internal terminal may be connected to external terminal 203 simultaneously. Conventionally such connections are made by means of bond-wires, but other known ways may also be used. The reference voltage Vref depends on which of the connecters T1, T2, Tm is connected to external terminal 103 and a signal applied at external terminal 103.
Advantages of the invention are:
just one mask set and one version on stock for the different output voltages.
very small extra chip area (only bondpads).
flexibility at the customer to change the output voltage some weeks before the delivering of the linear voltage regulators.
possibility to change one metal-mask for more, not selectable on forehand, output voltage levels.
fail Safe, as the output voltage is determined by the bondwires, and not by the customer.
trimming can be very accurate at final testing as there is just one output voltage to trim; this is not possible if the selection is not done by bonding but externally in the application by pulling one or more pins to ground or to a higher voltage.

FIG. 2 shows a schematic diagram of an embodiment of the voltage regulator circuit arrangement according to the invention. The arrangement 200 comprises a voltage regulator 202 that in operation supplies an output voltage Vout at its output 204. The output voltage Vout is generated in dependence of a reference voltage Vref supplied at its input. The reference voltage Vref is generated by a reference voltage generation circuit 201. The reference voltage generation circuit has a plurality of inputs which are connected to corresponding internal terminals T1, T2, . . . , Tm. A sub-set of the internal terminals T1, T2, . . . , Tm is connected to an external terminal 203. In FIG. 2 only internal terminal Tm−1 is connected to external terminal 203 as is indicated by the continuous line between internal terminal Tm−1 and external terminal 203. Possible connections between other internal terminals and external terminal 203 are indicated by broken lines. It will be clear that a number of internal terminal may be connected to external terminal 203 simultaneously.

In the shown embodiment reference signal generation circuit 201 comprises a resistive ladder network. In the shown resistive ladder network a plurality of resistors R1, R2, . . . , Rn−1, Rn are connected in series. An electrode of the first resistor R1 is connected to a supply voltage or another pre-determined voltage. Another electrode of resistor R1 is connected to an intermediate node 210 that further is connected to internal terminal T1 , a second resistor R2, and coupled to the input of the voltage regulator 202 for supplying the reference voltage Vref. An electrode of the last resistor Rn is connected to internal terminal Tn. Another electrode of resistor Rn is connected an intermediate node 211 that is further connected to internal terminal Tn−1 and an electrode of resistor Rn−1. Other internal terminals are connected to other intermediate nodes in the resistive ladder network.

By connecting a different internal terminal to external terminal 203 the voltage division ratio of the resistive ladder network will change, resulting in a different reference voltage Vref being generated in response to the same input voltage provided at the external terminal 203. Alternatively a number of internal terminals may be connected to external terminal 203, thereby short-circuiting a part or parts of the resistive ladder network, resulting in the voltage division ratio to be changed. Depending on the application it may be advantageously that all resistors have the same value or that individual resistors have different values.

FIG. 3 shows a schematic diagram of another further embodiment of the voltage regulator circuit arrangement according to the invention. The arrangement 300 comprises a linear voltage regulator 302 that in operation supplies an output voltage Vout at its output node 315. The output voltage Vout is generated in a conventional way in dependence upon a first reference voltage Vbg, generated by a band-gap voltage reference circuit 301, supplied at a non-inverting input of the voltage regulator 302 and a second reference voltage Vref supplied at an inverting input of the voltage regulator 302. The second reference voltage Vref is generated by a reference voltage generation circuit comprising a resistive ladder network comprising a plurality of resistors R1, R2, R3, R4, R5, R6, . . . , Rn connected in series between node 315 and a node at a fixed voltage level, for instance ground. The resistive ladder network has a plurality of inputs formed by circuit nodes within the resistive ladder network which are connected to corresponding internal terminals T1, T2, . . . , Tm. A sub-set of the internal terminals T1 , T2, . . . , Tm is connected to an external terminal 303. In FIG. 3 only internal terminal Tm is connected to external terminal 303 as is indicated by the continuous line between internal terminal Tm and external terminal 303. Possible connections between other internal terminals and external terminal 303 are indicated by broken lines. It will be clear that more than a number of internal terminal may be connected to external terminal 303 simultaneously. Conventionally such connections are made by for instance bond-wires.

In the resistive ladder network resistor R1 is connected between ground and node 310, which is further coupled to the inverting input of voltage regulator 302 for supplying the reference voltage Vref. Resistor R2 is connected between node 310 and node 311. Resistor R3 is connected between node 311 and node 312, which is further connected to internal terminal T1. Resistor R4 is connected between node 312 and node 313, which is further connected to internal terminal T2. Resistor R5 is connected between node 313 and node 314, which is further connected to internal terminal T3. Resistor R6 is connected to node 314 and via further resistors and nodes resistor coupled to resistor Rn. Resistor Rn, the last resistor in the resistive ladder network is connected to node 315, which is further connected to internal terminal Tm.

In FIG. 3 only internal terminal Tm is connected to external terminal 303 as is indicated by the continuous line between internal terminal Tm and external terminal 303. Possible connections between other internal terminals and external terminal 303 are indicated by broken lines. It will be clear that a number of internal terminal may be connected to external terminal 303 simultaneously.

By connecting additional internal terminal to external terminal 203 the voltage division ratio of the resistive ladder network will change, resulting in a different reference voltage Vref being generated in response to the same input voltage provided at the external terminal 303. Alternatively a number of internal terminals may be connected to external terminal 303, thereby short-circuiting a part or parts of the resistive ladder network, resulting in the voltage division ratio to be changed. Depending on the application it may be advantageously that all resistors have the same value or that individual resistors have different values.

In a typical application all elements shown in FIG. 3, except external terminal 303 are part of an integrated circuit located on a semiconductor material die. Internal terminals T1 , . . . , Tm are the terminals of the integrated circuit and are realized for instance in the form of bond pads. In this application external terminal 303 is an internal terminal of an integrated circuit (IC) package, for instance a lead finger, which is connected to an external terminal of the IC package, for instance a connector in the form of a pin or another conventional electrical contact.

The regulator regulates the output voltage to the voltage Vout in such a way that Vref is equal to the band-gap voltage Vbg. The output voltage Vout is equal to:
Vout=Vref*(Rtot/R1), with
Rtot=R1+R230 R3+R4+R5+R6+ . . . +Rn (1)

In conventional linear voltage regulators only bond-wire between bond-pad Tm to the lead-finger 303 of the package has been mounted, resulting in a maximum output voltage Vout,max on the lead-finger 303 and therefore the corresponding pin of the package:
Vout,max=Vref*(Rtot,max/R1), with
Rtot,max=R1+R2+R3+R4+R5+R6+ . . . +Rn. (2)

When one of the extra bond-wires has been added from respectively bond-pad T3, T2 or Ti to the lead-finger 303, a short has been made across the resistors R6 to Rn, or R5 and R6 to Rn, or R4, R5 and R6 to Rn respectively, resulting in a lower output voltage. The total resistor Rtot in formula (1) from Vo to ground will decrease to:

R1+R2+R3+R4+R5, R1+R2+R3+R4 and R1+R2+R3 respectively. The value of the resistors determines the different output voltages.

The extra chip area is minimum: just the extra bond-pads. The number of bond-pads (three in this example) is not fixed to three, the minimum is one. Another advantage is that if the band-gap-voltage Vbg can be trimmed also the output-voltage can be trimmed very accurate at final-testing for that particular output voltage. The choice of the number and value of resistors depends on all expected output voltages, even if the voltage is not selected in the first IC. By changing one metal mask whereby the bond-pads T3, T2 and/or T1 are wired to another place in the resistor-bleeder new output voltages can be selected.

Typical resistor values are: R1=10 kOhm, R2=R3=5 kOhm, R4=4 kOhm, R5=2.4 kOhm and the sum of R6 to Rm 32 13.6 kOhm. This results, together with a bandgap-voltage of approx. 1.25V in the following possible output voltages:

5.0V (one bond-wire, only on bond-pad Tm),

3.3V (bond-wires to bond-pad Tm and T3),

3.0V (bondwires to bondpad Tm and T2), and

2.5V (bondwires to bondpad Tm and T1).

FIG. 4 shows a schematic diagram of another further embodiment of the voltage regulator circuit arrangement according to the invention. The arrangement 400 is a modified version of the arrangement shown in FIG. 3. It comprises a linear voltage regulator 402 that in operation supplies an output voltage Vout at its output node 415. The output voltage Vout is generated in a conventional way in dependence upon a first reference voltage Vbg, generated by a band-gap voltage reference circuit 401, supplied at a non-inverting input of the voltage regulator 402 and a second reference voltage Vref supplied at an inverting input of the voltage regulator 402. The second reference voltage Vref is generated by a reference voltage generation circuit comprising a resistive ladder network comprising a plurality of resistors R1 , R2, R3, R4, R5, R6, . . . , Rn, and Ra, Rb, Rc, Rd, Re, Rf, and Rg connected between node 315 and a node at a fixed voltage level, for instance ground. The resistive ladder network has a plurality of inputs formed by circuit nodes within the resistive ladder network which are connected to corresponding internal terminals T1 , T2, . . . , Tm. A sub-set of the internal terminals T1 , T2, . . . , Tm is connected to an external terminal 403. In FIG. 4 only internal terminal Tm is connected to external terminal 403 as is indicated by the continuous line between internal terminal Tm and external terminal 403. Possible connections between other internal terminals and external terminal 403 are indicated by broken lines. It will be clear that more than a number of internal terminal may be connected to external terminal 403 simultaneously. Conventionally such connections are made by for instance bond-wires.

In the resistive ladder network resistor R1 is connected between ground and node 410, which is further coupled to the inverting input of voltage regulator 302 for supplying the reference voltage Vref. Resistor R2 is connected between node 410 and node 411. Resistor R3 is connected between node 411 and node 412. Resistor R4 is connected between node 412 and node 413. Resistor R5 is connected between node 413 and node 414. Resistor R6 is connected to node 414 and via further resistors and nodes resistor coupled to resistor Rn. Resistor Rn, the last resistor in the resistive ladder network is connected to node 415, which is further connected to internal terminal 315. Resistor Ra is connected between node 412 and node 421. Resistor Rb is connected between node 412 and node 420. Resistor Rc is connected between node 414 and node 421. Resistor Rd is connected between node 414 and node 420. Resistor Re is connected between node 420 and node 421. Resistor Rf is connected between node 415 and node 421. Resistor Rg is connected between node 415 and node 420. Internal terminal Tm is connected to node 415. Internal terminal T2 is connected to node 420. Internal terminal T1 is connected to node 421.

In FIG. 4 only internal terminal Tm is connected to external terminal 403 as is indicated by the continuous line between internal terminal Tm and external terminal 403. Possible connections between other internal terminals and external terminal 403 are indicated by broken lines. It will be clear that a number of internal terminal may be connected to external terminal 403 simultaneously.

In a typical application all elements shown in FIG. 4, except external terminal 403 are part of an integrated circuit located on a semiconductor material die. Internal terminals T1, . . . , Tm are the terminals of the integrated circuit and are realized for instance in the form of bond pads. In this application external terminal 403 is an internal terminal of an integrated circuit (IC) package, for instance a lead finger, which is connected to an external terminal of the IC package, for instance a connector in the form of a pin or another conventional electrical contact.

The advantage of the arrangement of FIG. 4 compared with the arrangement of FIG. 3 is that it possible to generate additional values of Vout without introducing additional bond-pads. Alternatively one bond-pad less is required to generate four different output voltages. Typical resistor values are R1=10 kOhm, R2=R3=0 Ohm, R4+R5=15 kOhm, the sum of R6 to Rm=30 kOhm, Ra=20 kOhm, Rb=Rc=Re=infinite, Rd=6 kOhm, R1=130 kOhm and Rg=84 kOhm. This results, together with a band-gap voltage of approximately 1.25V in the following possible output voltages:

5.00V (one bond-wire, only on bond-pad Tm),

3.46V (bond-wires on bond-pad Tm and T2),

2.88V (bond-wires on bond-pad Tm and T1), and

2.50V (bond-wires to bond-pad Tm, T2 and T1).

FIG. 5 shows a schematic diagram of another further embodiment of the voltage regulator circuit according to the invention. The arrangement comprises a linear voltage regulator 502 that in operation supplies an output voltage Vout at its output node 530. output node 530 is connected to an inverting input of linear voltage regulator 502. A controlled voltage source 503 generates a reference voltage Vref in dependence upon an digital output circuit generated by digital circuit 501. An output of a first comparator 510 is connected to a first input of digital circuit 502. An output of a second comparator 520 is connected to a second input of digital circuit 502. A non-inverting input of the first comparator 510 is connected to node 532. At an inverting input of the first comparator a first threshold voltage Vth,h is provided. A non-inverting input of the second comparator 520 is connected to node 531. At an inverting input of the second comparator a second threshold voltage Vth,1 is provided. Node 532 is connected to an internal terminal Ta. Furthermore a current source 512, generating a first current Ih, is connected between node 532 and a node at a fixed voltage, for instance ground. Node 531 is connected to an internal terminal Tb. Furthermore a current source 522, generating a second current 11, is connected between node 531 and a node at a fixed voltage, for instance ground. Node 530 is connected to internal terminal To.

In a typical application voltage regulator arrangement 500 is part of an integrated circuit, whereby internal terminals Ta, Tb, and To are the terminals of the IC, typically formed as bond-pads. The output voltage Vout of the output buffer, connected to the bondpad To, which is mounted to a corresponding lead finger of a package, will be equal to the selectable voltage Vref of the voltage source 503. The voltage of the voltage source 503 depends on the signals provided at the outputs of the comparators 510 and 520.

If bond-pad Ta is not mounted via a bond-wire to the lead-finger of To, the input signal of comparator 510 is equal to the ground-level due to the current source Ih, resulting in a low level of the output signal of comparator 510. If bond-pad Ta is mounted via a bond-wire to the lead-finger of To, the input signal of comparator 510 is equal to Vout, and with a threshold of comparator 510 lower than the minimum selectable Vout, the output signal of comparator 510 is high.

If bond-pad Tb is not mounted via a bond-wire to the lead-finger of Vout, the input signal of comparator 520 is equal to the ground level due to the current source 11, resulting in a low level of the output signal of comparator 520. If bondpad Tb is mounted via a bond-wire to the lead-finger of Vout, the input signal of comparator 520 is equal to Vout, and with a threshold of comparator 520 lower than the minimum selectable Vout signal, the output signal of comparator 520 is high.

With the output signals of the comparators 510 and 520 both depending on the presence or absence of the bond-wires from the lead-finger of the output voltage to the bond-pads Ta and Tb respectively, four different output levels can be selected. The levels Vth,h and Vh,l are lower than the minimum selectable output voltage. The reason is that during start-up of the voltage regulator, which is the ramping up of the output voltage Vo, the digital circuit has to decide on which level Vout will stop. If the two bond-pads are not mounted Vout stops at the minimum output voltage. If only bond-pad Ta is mounted, Vout stops at a value somewhat higher. If only bond-pad Ta is mounted, Vout stops at the value higher than the second one. If both bond-pads have been mounted, Vout ramps up to the maximum output voltage.

With the choice of these comparator levels, Vout will ramp-up smoothly, as it is already known during the ramp-up when Vout is nearly equal to the minimum selectable output voltage to what voltage Vout has to ramp up. Vt,h can be higher than Vt,l, but this is not needed.

The digital circuitry can look continuously to the levels of the output signals of the comparators 510 and 520. Alternatively it can also decide to store the information once during the first ramping up of Vout. The advantage of the latter is that spikes on Vout will not influence the decision for the selected Vout, and that the current sources 512 and 522 and the comparators 510 and 520 can be switched off. This saves power supply current.

Typically the currents Il and Ih are in the range of 10-100 μA. The thresholds Vth,l and Vth,h are in the range of 1-2V, and the selected output voltage Vout between 2V and 5V. The number of extra bond-pads (Ta and Tb in this example) is not fixed to two, it can be more or less, depending on the number of wanted selectable output voltages.

The embodiments of the present invention described herein are intended to be taken in an illustrative and not a limiting sense. Various modifications may be made to these embodiments by those skilled in the art without departing from the scope of the present invention as defined in the appended claims.

For instance in the above discussed embodiments the reference signal is a voltage domain signal. It will be clear to a skilled person that instead of a voltage domain signal a signal in for instance the current or charge domain could be used if a suitable reference generation circuit is provided.

Furthermore although in the embodiments shown in FIG. 2, FIG. 3, and FIG. 4 resistive ladder networks are used to divide a signal provided at an external terminal, it will be clear that other kinds of voltage divider circuits may be applied equally well, or in case current or charge domain reference signals are to be generated, current, respectively charge divider circuits.

The voltage regulator circuit arrangement according to the invention can be used in applications whereby a range of power supply voltages are common, or as stand-alone product, or as part of a system in which one or more voltage regulators are integrated.

1. A voltage regulator circuit arrangement comprising a voltage regulator for generating an output voltage in dependence of a reference signal, characterized in that a reference signal generation circuit is provided for generating said reference signal comprising a plurality of inputs connected to internal terminals, whereby a sub-set of said plurality internal terminals is connected to an external terminal.

2. A voltage regulator circuit arrangement as claimed in claim 1, characterized in that said reference signal generation circuit comprises a selection circuit for selecting said reference signal out of a range of possible reference signals in dependence upon a selection signal received at said external terminal.

3. A voltage regulator circuit arrangement as claimed in claim 2, characterized in that said reference signal generation circuit comprises a comparator with an input connected to an internal terminal out of said sub-set of internal terminals for comparing said selection signal with a threshold signal and an output connected to said selection circuit.

4. A voltage regulator circuit arrangement as claimed in claim 3, characterized in that said reference signal generation circuit comprises a further comparator with an input connected to a further internal terminal out of said sub-set of internal terminals for comparing said selection signal with a further threshold signal and an output connected to said selection circuit.

5. A voltage regulator circuit arrangement as claimed in claim 2, characterized in that said plurality of internal terminals comprises a further sub-set of internal terminals connected to a further external terminal for receiving a further selection signal, whereby said reference signal generation circuit comprises a further comparator with an input connected to an internal terminal out of said further sub-set of internal terminals for comparing said further selection signal with a further threshold signal and an output connected to said selection circuit.

6. A voltage regulator circuit arrangement as claimed in claim 1, characterized in that said reference signal generation circuit comprises a voltage divider circuit whereby said inputs correspond to the inputs said voltage divider circuit and said reference signal is provided at an output of said voltage divider circuit.

7. A voltage regulator circuit arrangement as claimed in claim 6, characterized in that said voltage divider circuit is a resistive ladder network.

8. A voltage regulator circuit arrangement as claimed in claim 7, characterized in that a said selection of internal terminals connected to said external terminal short circuits a section of said resistive ladder network.

9. A voltage regulator circuit arrangement as claimed in claim 1, characterized in that said voltage regulator comprises an output for providing said output voltage, whereby said output is connected to an internal terminal out of said plurality of internal terminals.

10. An integrated circuit comprising a voltage regulator circuit comprising a voltage regulator for generating an output voltage in dependence of a reference signal, characterized in that a reference signal generation circuit is provided for generating said reference signal comprising a plurality of inputs connected to terminals of said integrated circuit.
